(19) United States
(12) Patent Application Publication
(10) Pub. No.: US 2026/0228794 A1
(43) Pub. Date: Aug. 6, 2026

(54) ITEM SELECTION USING SHARED PARAMETERS

(71) Applicant: Walmart Apollo, LLC, Bentonville, AR (US)

(72) Inventors: Zhihao Huang, Hayward, CA (US); Ankur Bhardwaj, Milpitas, CA (US); Afroza Ali, Los Altos, CA (US)

(21) Appl. No.: 19/042,810

(22) Filed: Jan. 31, 2025

(51) Int. Cl. G06Q 30/0601; G06F 18/2321

(52) U.S. Cl. CPC G06Q 30/0629; G06F 18/2321

(57) ABSTRACT

Example implementations related to explore-exploit item recommendation using shared parameters are disclosed. In an example, interaction data for a set of candidate items is received, distribution parameters is determined for the candidate items, and updated distribution parameters are generated based on a mean of the distribution parameters. At least one updated parameter is associated with a first cluster of the candidate items. A subset of candidate items is ranked based on the of updated distribution parameters using an explore-exploit process and instructions are generated that cause an interface to be displayed on a user device. The interface includes at least a portion of the subset of candidate items in rank order. An interaction with at least one candidate item of the subset of candidate items is received from the user device and the set of distribution parameters is updated based on the interaction with the at least one candidate item.

### TECHNICAL FIELD

This application relates generally to interface generation, and more particularly, to interface element selection using shared parameters.

### BACKGROUND

Some network systems generate interfaces including selected or recommended interface elements representative of catalog items. Such network systems may select elements for inclusion in interfaces based on parameters of the elements and/or underlying items. Generated interfaces may be provided to user devices to enable user interactions with the network system.

### BRIEF DESCRIPTION OF THE DRAWINGS

Various examples will be described below with reference to the following figures.

FIG. 1 depicts an example system for explore-exploit item selection using shared parameters, in accordance with some embodiments.

FIG. 2 depicts a clustering process, in accordance with some embodiments.

FIG. 3 depicts a flow diagram illustrating a method of explore-exploit selection using shared parameters, in accordance with some embodiments.

FIG. 4 depicts a flow diagram illustrating a method of generating shared parameters for items in a cluster, in accordance with some embodiments.

FIG. 5 depicts an example system with a machine-readable medium that includes instructions for explore-exploit selection using shared parameters, in accordance with some embodiments.

FIG. 6 depicts an example system with a machine-readable medium that includes instructions for generating shared parameters for items in a cluster, in accordance with some embodiments.

FIG. 7 depicts an example computer system that implements one or more of the disclosed processes, in accordance with some embodiments.

### DETAILED DESCRIPTION

Some large scale network systems rely on exploration-exploitation mechanisms (e.g., explore-exploit processes) to generate interface element recommendations and mitigate cold starts when elements (e.g., items) are included in or added to a catalog without significant interaction history. Exploration-exploitation mechanisms also enable identification of changing user interaction trends by identifying items based both on historical interaction data (e.g., exploitation processes) and based on direct element or item parameters (e.g., exploration processes). While exploration-exploitation systems enable development of interaction data for low-interaction items, such systems are inefficient for network systems with large candidate pools (e.g., ecommerce systems with large item catalogs). In some instances, a large candidate pool may cause relevant items to be skipped, as they lack both historical interaction data that may be used by an exploitation mechanism and are not selected (due to the large number of candidates available) by an exploration mechanism.

The disclosed systems and methods provide an exploration-exploitation based item recommendation system that utilizes shared parameters to further mitigate cold starts and ensure all items have sufficient features for identification by an explore-exploit mechanism. In some embodiments, an online learning system applies a clustering process to generate clusters including candidate elements (e.g., candidate items) having significant interaction histories and elements having little or no interaction history. After clustering, parameters of one or more selected elements (e.g., selected items) having significant interaction histories and satisfying at least one additional criteria (e.g., having a highest interaction rate for elements in a cluster) are imputed to elements of the cluster without significant interaction history. By utilizing clustering and shared parameters (e.g., imputation of parameters for one item within a cluster to one or more other items in a cluster), the disclosed systems and methods allow relevant elements without significant interaction history to be identified by an exploration mechanism of an explore-exploit process.

In some embodiments, the disclosed systems and methods provide interfaces that increase user engagement with network systems. For example, when relevant elements are identified by the disclosed systems and methods through shared parameters, the relevant elements are presented to users via one or more interfaces. Users may interact with the presented elements. Sharing of parameters within a cluster enables elements that otherwise would not be identified by an exploitation mechanism to be identified when relevant and provided via one or more interfaces, increasing user engagement and generating additional interaction data that may be used to independently identify the relevant elements in future iterations and/or may be imputed to other elements in the shared cluster.

In various embodiments, a system including a processor and a non-transitory memory storing instructions is disclosed. The instructions, when executed, cause the processor to receive interaction data for a set of candidate items, determine a set of distribution parameters for the set of candidate items using the interaction data, and generate a set of updated distribution parameters based on a mean of the set of distribution parameters. At least one updated parameter is associated with a first cluster of the set of candidate items. The instructions further cause the processor to rank a subset of candidate items based on the of updated distribution parameters using an explore-exploit process and generate instructions that cause an interface to be displayed on a user device. The interface includes at least a portion of the subset of candidate items in rank order. The instructions further cause the processor to receive an interaction with at least one candidate item of the subset of candidate items from the user device and update the set of distribution parameters based on the interaction with the at least one candidate item.

In various embodiments, a computer-implemented method is disclosed. The computer-implemented method includes steps of receiving interaction data for a set of candidate items, determining distribution parameters for the set of candidate items using the interaction data, and generating updated distribution parameters for the set of candidate items. The set of candidate items is clustered and the updated distribution parameters are generated based on at least one shared parameter of a first cluster and a mean of the distribution parameters. The computer-implemented method further includes ranking a subset of candidate items based on the updated distribution parameters using an explore-exploit process and generating instructions that cause an interface to be displayed on a user device. The interface includes at least a portion of the subset of candidate items in rank order. The computer-implemented method further includes steps of receiving an interaction with at least one candidate item of the candidate items from the user device and updating the distribution parameters based on the interaction data and the interaction with the at least one candidate item.

In various embodiments, a non-transitory computer-readable medium storing instructions is disclosed. The instructions, when executed by at least one processor, cause a device to perform operations including receiving interaction data for a set of candidate items, determining distribution parameters for the interaction data, and generating updated distribution parameters for the set of candidate items. The set of candidate items is clustered and the updated distribution parameters are generated based on at least one shared parameter of a first cluster. The instructions further cause the device to perform operations including ranking a subset of candidate items based on the updated distribution parameters using an explore-exploit process and generating instructions that cause an interface to be displayed on a user device. The interface includes at least a portion of the subset of candidate items in rank order. The instructions further cause the device to perform operations including receiving an interaction with at least one candidate item of the subset of candidate items from the user device and updating the distribution parameters based on the interaction data and the interaction with the at least one candidate item.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired or wireless) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for explore-exploit item recommendation using shared parameters. In various embodiments, one or more candidate items (e.g., elements representative of candidate items) are selected from a catalog of items. At least one of the candidate items includes historical interaction data associated therewith. The candidate items are clustered into one or more clusters via a clustering process, such as a semantic clustering process based on one or more high dimension semantic embeddings. For each cluster, at least one item satisfying at least one criteria (e.g., interaction quantity) is selected and one or more distribution parameters of the selected item are imputed to one or more other items of the corresponding cluster. The candidate items (or a subset thereof) are subsequently ranked based on the updated distribution parameters. At least some of the ranked items are included in a user interface and interaction data is received for the user interface. Item parameters (e.g., distributions) may be updated in response to the received interaction data for the user interface.

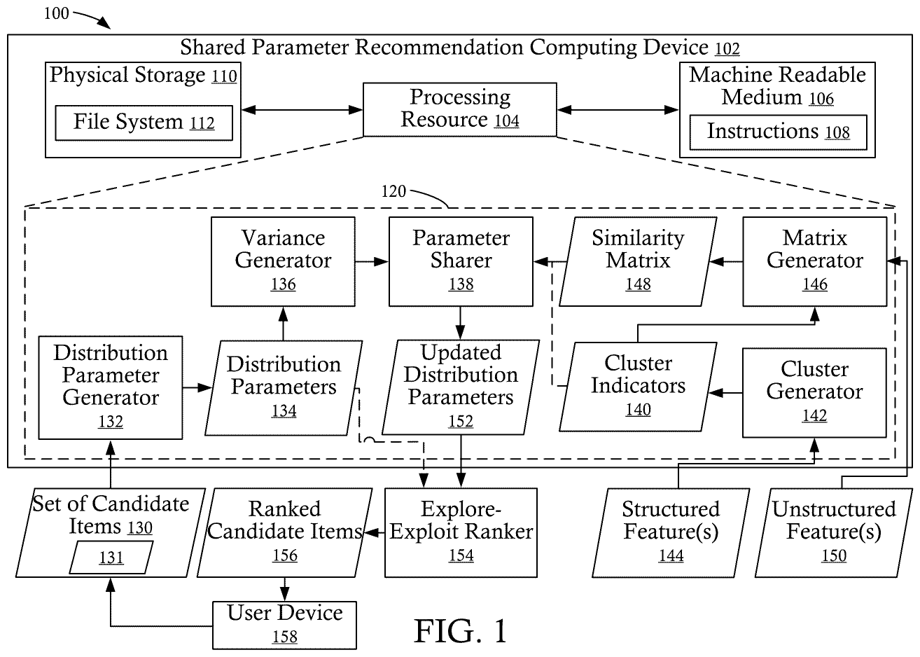

FIG. 1 depicts an example system 100 that provides item recommendation utilizing shared parameters, in accordance with some embodiments. The system 100 includes a shared parameter recommendation computing device 102 that identifies items for inclusion in an interface from a set of candidate items based, at least in part, on shared parameters. The shared parameter recommendation computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The shared parameter recommendation computing device 102 includes a non-transitory machine readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the shared parameter recommendation computing device 102, such as clustering, parameter imputation, and/or item recommendation. The instructions 108 may include instructions for implementing one or more models. In some embodiments, and as will be described further herein below, the shared parameter recommendation computing device 102 may execute one or more models, processes, or algorithms, such as a machine learning model, deep learning model, statistical model, etc., (e.g., as implemented as machine readable instructions) to cluster one or more candidate items and/or select one or more items for inclusion in an interface.

The shared parameter recommendation computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (e.g., installed) in the shared parameter recommendation computing device 102. In some implementations, physical storage 110 may be accessed as a block storage device.

In some cases, the shared parameter recommendation computing device 102 may also include a local file system 112 that may be implemented as a layer on top of the physical storage 110. For example, an operating system may be executing on the shared parameter recommendation computing device 102 (by virtue of the processing resource 104 executing certain instructions 108 related to the operating system) and the operating system may provide a file system 112 to store data on the physical storage 110.

The shared parameter recommendation computing device 102 may be in communication with one or more additional devices over one or more network channels. For example, in various embodiments, the shared parameter recommendation computing device 102 may be in communication with a web server, a cloud-based engine including one or more processing devices that may be provisioned for use, a database, a workstation, and/or any other suitable system or device. The shared parameter recommendation computing device 102 may similarly be in communication, either directly or indirectly, with one or more user computing devices operatively coupled over the network. The other computing systems may be similar to the shared parameter recommendation computing device 102, and may each include at least a processing resource and a machine readable medium.

In some embodiments, the shared parameter recommendation computing device 102 implements a shared parameter recommender 120. For example, shared parameter recommender 120 may be executed by the processing resource 104. In some embodiments, data representative of a set of candidate items 130 is received by the shared parameter recommender 120, such as by a distribution parameter generator 132. The set of candidate items 130 may include data representative of one or more elements associated with a network environment, such as one or more candidate items obtained from an item catalog associated with the network environment. In some embodiments, the candidate items 130 include corresponding interaction data 131 for each of the one or more elements in the set of candidate items 130.

In some embodiments, the distribution parameter generator 132 receives the candidate items 130 and generates a set of distribution parameters 134 for the candidate items 130 based on corresponding interaction data 131. The distribution parameters 134 may include any suitable distribution and/or may be generated for use in any suitable post-generation process, such as, for example, a Thompson sampling process (e.g., a Bayesian-based Thompson sampling approach). The distribution parameter generator 132 may generate a posterior distribution. In some embodiments, the distribution parameters 134 are generated for an item exploitation process. The distribution parameters 134 may include one or more parameters, such as, for example, a first parameter (e.g., a) and a second parameter (e.g., B). Although certain example embodiments are discussed herein, it will be appreciated that the distribution parameters 134 may include any suitable parameters representative of a selected distribution.

In some embodiments, the distribution parameters 134 are provided to a variance generator 136 that identifies a mean or variance of one or more of the distribution parameters 134. For example, in embodiments including an a parameter and a β parameter, the variance generator 136 may generate a variance of a beta distribution. The variance generator 136 may implement any suitable process for determining a variance. For example, in some embodiments, a mean

$$( {μ}_{i}^{( t )} )$$

and a variance

$$( {σ}_{i}^{( t )} )$$

of an item (i) in a beta distribution including a and β parameters is represented as:

$${μ}_{i}^{( t )} = \frac{{α}_{i}^{( t )}}{{α}_{i}^{( t )} + {β}_{i}^{( t )}}$$

$${σ}_{i}^{( t )} = \frac{{α}_{i}^{( t )} {β}_{i}^{( t )}}{( {α}_{i}^{( t )} + {β}_{i}^{( t )} ) ( 1 + {α}_{i}^{( t )} + {β}_{i}^{( t )} )}$$

In some embodiments, the mean and/or the variance of the distribution parameters 134 is provided to a parameter sharer 138 for use in parameter updating. As discussed in greater detail below, the parameter sharer 138 may identify one or more elements meeting one or more criteria (e.g., having a mean and/or a variance below or above a predetermined threshold) and may update one or more parameters of the identified elements.

In some embodiments, the parameter sharer 138 updates or shares parameters on a cluster-by-cluster basis. For example, the parameter sharer 138 may receive a set of cluster indicators 140 generated by a cluster generator 142. Cluster indicators 140 may be generated for each item in the set of candidate items 130 by applying one or more clustering algorithms (e.g., each item in the set of candidate items 130 may be clustered into one of a plurality of clusters each associated with a cluster identifier). In some embodiments, the cluster generator 142 applies a density-based spatial clustering of applications with noise (DBSCAN) process to cluster the set of candidate items 130 and generate the cluster indicators 140.

In some embodiments, the cluster generator 142 obtains (e.g., receives or loads from a data store) one or more structured features 144 associated with the set of candidate items 130. The structured features may include, but are not limited to, numerical attributes associated with each item such as item revenue, item price, average rating, etc. and/or categorical attributes such as brand, product category, product type, etc. The structured features 144 may be provided to the cluster generator 142 and/or generated (e.g., identified) as part of the applied clustering process.

The clustering process may identify clusters such that each cluster satisfies one or more predetermined criteria. For example, in some embodiments, a DBSCAN process is applied such that each cluster includes a predetermined minimum number of “hot” items, e.g., items having one or more parameters (e.g., interaction value, average rating) over a predetermined threshold during a predetermined period. Although certain example embodiments are discussed herein, it will be appreciated that a clustering process may be selected to satisfy any selected predetermined criteria.

In some embodiments, the cluster indicators 140 are provided to a matrix generator 146 for use in generation of a similarity matrix 148. The similarity matrix 148 may be generated based on a semantic context of each item in the set of candidate items 130. For example, the matrix generator 146 may generate semantic embeddings for each candidate item in the set of candidate items 130, such as using an embedding model such as a Bidirectional Encoder Representations from Transformers (BERT) model, and may generate a similarity measure (e.g., a cosine similarity) for each element pair in a corresponding set of candidate items 130 (e.g., each item in a catalog, a subset of items in a catalog). The similarity matrix 148 may include a matrix indicating each element pair and the corresponding similarity measure. The matrix generator 146 may receive one or more unstructured features 150, such as semantic features (e.g., title, description) for each candidate item.

In some embodiments, a similarity value S for a first item i and a second item j may be represented as S_{i,j}∈(0,1), where S_{i,j}=1. The similarity matrix 148 may be limited to similarity values for items in the same cluster to eliminate unwanted parameter sharing between clusters. For example, a similarity value S_{i,i} for a first item i and a second item j may be generated according to:

$${S}_{i , j} = {I}_{( s a m ecluster )} ( i , j ) * \frac{{E}_{i} \cdot {E}_{j}}{‖ {E}_{i} ‖ ‖ {E}_{j} ‖}$$

where I_{(samecluster)}(i, j) is an indicator function that identifies whether the first item i and the second item j are in the same cluster. In some embodiments, the indicator function may generate a value of zero for item pairs where the items are not in the same cluster and a value of one for item pairs where the items are in the same cluster. When a similarity value is zero (e.g., when the indicator function indicates the items are not in the same cluster and/or the similarity calculation is zero), the item pair may be excluded from the similarity matrix. In some embodiments, an indicator function may be checked as an initial step and a similarity value is not determined for item pairs where the items are in different clusters.

In some embodiments, the parameter sharer 138 updates one or more parameters of one or more candidate items 130 in a cluster based on one or more additional items included in the corresponding cluster. The parameter sharer 138 may identify one or more candidate items 130 for receiving updated parameters based on one or more selection criteria. For example, in some embodiments, candidate items 130 may be selected to receive shared (e.g., updated) parameters when the current parameters of the item (i) that satisfy the equation:

$${α}_{i}^{( t )} + {β}_{i}^{( t )} < ζ$$

where ζ is a predetermined threshold value (e.g., hyperparameter). Candidate items 130 selected for parameter updates may include “cold” items, e.g., items having an engagement value below a threshold value over a predetermined time period. Cold items may include, for example, new items added to the item catalog and/or existing items with limited interaction data.

In some embodiments, the candidate items 130 selected for parameter updating may be updated based on parameters of one or more additional items in a corresponding cluster. For example, in some embodiments, parameters of a selected candidate item 130 may be updated according to:

$${α}_{i}^{( t ) ′} = \frac{{\sum }_{j = 1}^{n} {S}_{i , j} * {I}_{( samecluster )} ( i , j ) * \frac{{μ}_{j}^{( t )}}{{σ}_{j}^{( t )}}}{{\sum }_{j = 1}^{n} {S}_{i , j} * {I}_{( sameclus er )} ( i , j ) * \frac{1}{{σ}_{j}^{( t )}}} \times ( {α}_{i}^{( t )} + {β}_{i}^{( t )} )$$

$${β}_{i}^{{( t )}^{′}} = {α}_{i}^{( t )} + {β}_{i}^{( t )} - {α}_{i}^{( t ) ′}$$

As previously discussed with respect to the similarity values, the I_{(samecluster)}(i, j) indicator function indicates that parameters are updated only on the basis of items that are grouped within the same cluster as the item being updated.

In some embodiments, the parameters of one or more candidate items 130 are updated based on a weighted average across the mean (μ^{t}) for a subset of items in the same cluster. In some embodiments, the second item j utilized for updating parameters of a first item i includes a “hot item” selected from the same cluster as the first item. For example, in some embodiments, the second item j includes an item having a highest engagement value for a corresponding network interface.

A set of updated distribution parameters 152 is generated by the parameter sharer 138. The set of updated distribution parameters 152 may include the original set of distribution parameters for a first subset of candidate items 130 and updated parameters generated by the parameter sharer 138 for a second subset of candidate items 130. The set of updated distribution parameters 152 may be provided to an explore-exploit ranker 154 to generate a set of ranked candidate items 156.

In some embodiments, the explore-exploit ranker 154 generates the set of ranked candidate items 156 from the set of candidate items 130 based, at least in part, on the updated distribution parameters 152. The explore-exploit ranker 154 may include an exploitation mechanism, such as a Thompson sampling process, that utilizes the updated distribution parameters 152 to select one or more candidate items 130 for inclusion in the set of ranked candidate items 156. The explore-exploit ranker 154 may additionally include an exploration mechanism, such as a multi-arm bandit process, for selecting one or more items for inclusion in the set of ranked candidate items 156. The updated distribution parameters 152 provide increased exploration of updated candidate items without impacting either the exploitation of non-updated candidate items or exploration of the candidate items 130 (e.g., only a point estimate is updated).

In some embodiments, the explore-exploit ranker 154 implements a multi-arm (e.g., n-arm) bandit process for determining the set of ranked candidate items 156. The explore-exploit ranker 154 may implement a click-through rate (CTR) model based on a Thompson Sampling process. For example, for a set of items at, with i∈{1, 2, . . . , n}, the probability of an impression may be given as:

$$ℙ ( {C}_{i} = 1 ) = {p}_{i}$$

In some embodiments, a Bayesian approach may be applied to determine an interaction probability of each item. An interaction probability may be provided as a Bayesian posterior as a product result of empirical distribution and prior distribution. Each impression may be considered as a Bernoulli trail with success probability of pᵢ. The likelihood of multiple interactions s and no-interaction impressions f may be modeled by a binomial distribution, where:

$$ℙ ( X \vert {p}_{i} ) = ( \begin{matrix}s + f \\ s\end{matrix} ) {{p}_{i}^{s} ( 1 - {p}_{i} )}^{f}$$

By utilizing conjugal properties of a binomial distribution, the prior of pᵢ may be set as Beta(α, β) with a posterior distribution given by:

$$ℙ ( X \vert {p}_{i} ) = Beta ( α + s , β + f ) := Beta ( α , β )$$

In some embodiments, ranking of the set of ranked candidate items 156 may be generated based on the interaction probability, pᵢ, such that:

$${p}_{i}^{t} ∼ Beta ( {α}_{i}^{( t )} , {β}_{i}^{( t )} )$$

where

$$Beta ( {α}_{i}^{( t )} , {β}_{i}^{( t )} )$$

represents the posterior distribution of pᵢ at time t. As discussed above, the values of

$${α}_{i}^{( t )} , {β}_{i}^{( t )}$$

may include updated parameter values based on shared parameters within a cluster.

In some embodiments, the set of ranked candidate items 156 is provided to a user device 158. For example, in some embodiments, at least a portion of the ranked candidate items 156 may be included in and/or represented in a user interface provided to the user device 158. The user interface may include one or more interface elements representative of a portion of the ranked candidate items 156 and provided for user interaction via a user device. In some embodiments, interaction data, such as interaction data 131, may be received as feedback data from the user device 158. The feedback data may be representative of one or more interactions with one or more of the ranked candidate items 156 presented via the user interface.

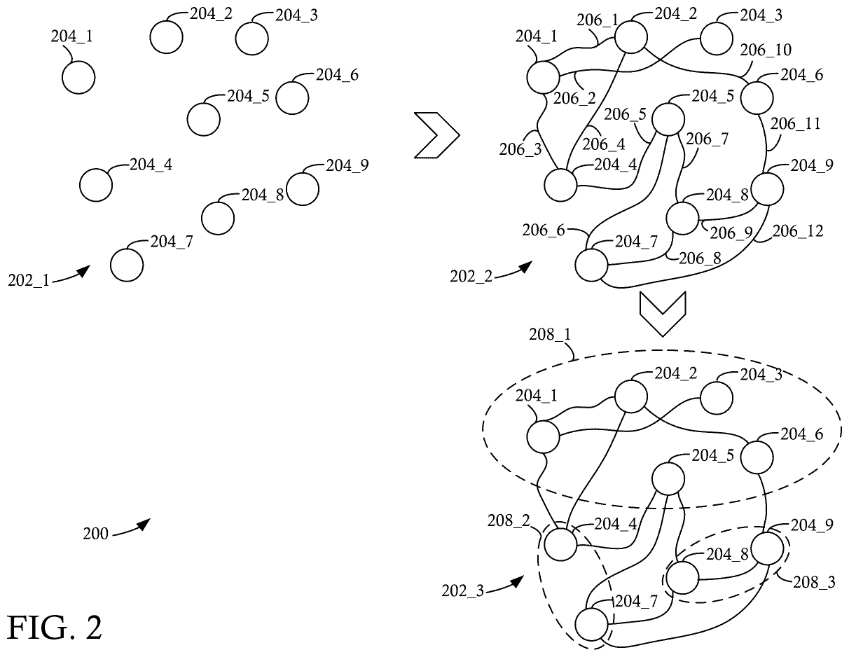

FIG. 2 depicts a clustering process 200, in accordance with some embodiments. At an initial step, a set of candidate items 202_1 including one or more items 204_1 to 204_9 (collectively “items 204”) may be received. The items 204 may be a portion of items included in a catalog associated with network environment, such as a set of items included in an ecommerce item catalog.

Each of the items 204 may be linked (e.g., connected) to one or more other items 204. In some embodiments, a first item may be linked to a second item based on semantic similarity as determined by unstructured features. Unstructured features may include, but are not limited to, item descriptions, item titles, and item images. A plurality of links 206_1 to 206_12 (collectively “links 206”) are generated between the items 204 to generate a linked set of candidate items 202_2.

The linked items 204 may be grouped into one or more clusters 208_1 to 208_3 (collectively “clusters 208”). The clusters 208 may be generated using structured features (e.g., price, brand, color) and/or based on high dimension semantic embedding-based similarities. Each of the clusters 208 may include a variable number of items 204. For example, in the illustrated embodiment, a first cluster 208_1 includes four items and each of a second cluster 208_2 and a third cluster 208_3 include two items. Although example embodiments are discussed herein, it will be appreciated that any suitable clustering process may be applied to generate one or more clusters 208.

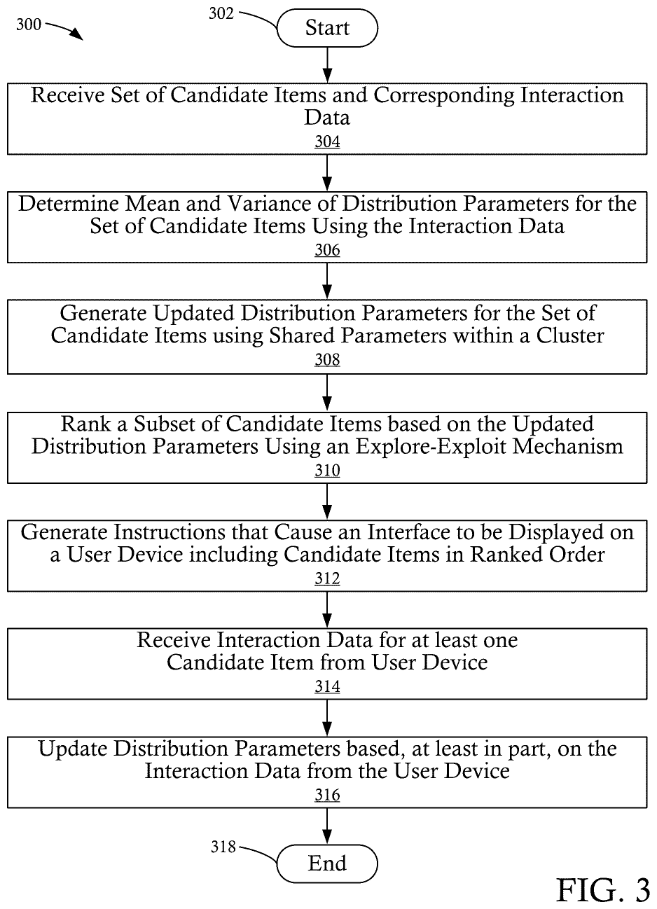

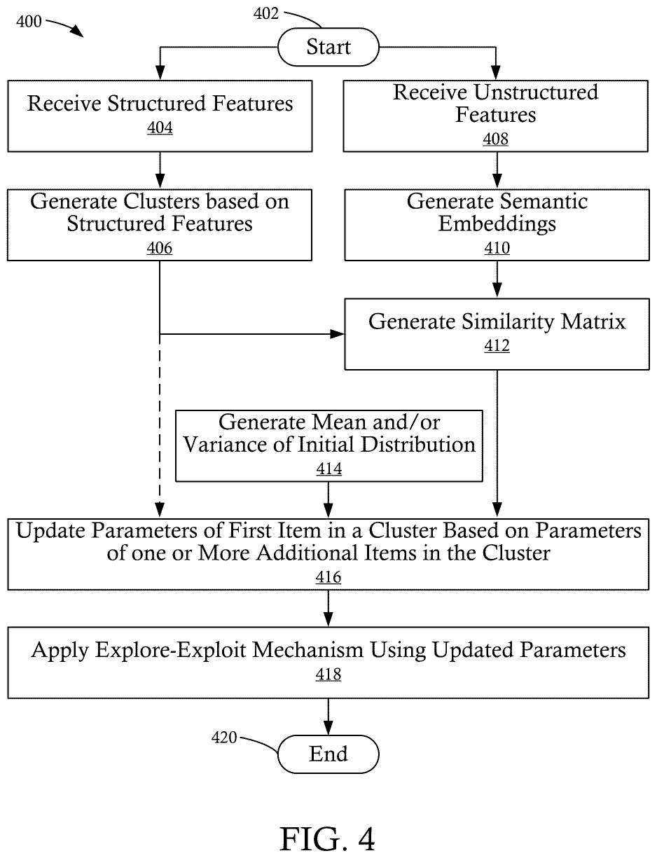

FIGS. 3 and 4 are flow diagrams depicting various example methods. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the methods may be combined.

The methods shown in FIGS. 3 and 4 may be implemented in the form of executable instructions stored on a machine-readable medium and executed by a processing resource and/or in the form of electronic circuitry. For example, aspects of the methods may be described below as being performed by an interface generation process based on shared parameters, an example of which may include the shared parameter recommender 120 running on a hardware processing resource 104 of the interface generation computing device 102 described above. Additionally, other aspects of the methods described below may be described with reference to other elements shown in FIG. 1 for non-limiting illustration purposes.

FIG. 3 depicts a flow diagram illustrating a method 300 of explore-exploit item selection using shared parameters, in accordance with some embodiments. Method 300 starts at block 302 and continues to block 304, where a set of candidate items including corresponding interaction data is received. The set of candidate items may include elements representative of one or more elements associated with a network environment, such as one or more candidate items obtained from an item catalog associated with the network environment, and corresponding interaction data for each of the one or more elements.

At block 306, a mean and a variance of a set of initial distribution parameters for the set of candidate items is determined using the interaction data. The mean and variance may be generated based on a distribution, such as a posterior distribution, generated for the set of candidate items. As discussed above with respect to FIG. 1, an initial distribution may be generated by a distribution generator and subsequently provided to a variance generator to determine a mean and/or variance of the initial distribution.

At block 308, updated distribution parameters are generated for the set of candidate items using shared parameters in a cluster. The shared parameters may be generated by clustering the set of candidate items into one or more clusters and modifying one or more parameters (e.g., a, B) of at least one candidate item in a cluster based on a weighted mean of one or more additional items in the corresponding cluster. For example, in some embodiments, parameters for one or more cold items may be updated based on a mean of one or more hot items in the same cluster.

At block 310, a subset of the candidate items is ranked based on the updated distribution parameters using an explore-exploit mechanism. The explore-exploit mechanism generates the subset of ranked candidate items from the set of candidate items based, at least in part, on the updated distribution parameters. The explore-exploit mechanism may include an exploitation mechanism, such as a Thompson sampling process, that utilizes the updated distribution parameters to select one or more candidate items for inclusion in the set of ranked candidate items. The explore-exploit mechanism may additionally include an exploration mechanism, such as a multi-arm bandit process, for selecting one or more items for inclusion in the set of ranked candidate items.

At block 312, instructions that cause an interface to be displayed on a user device are generated. The interface includes the ranked subset of candidate items in ranked order. The interface may be generated according to any suitable interface generation process, such as a template completion process. At block 314, interaction data for at least one candidate item in the ranked subset of candidate items is received from the user device and, at block 316, the distribution parameters for the set of candidate items is updated based, at least in part, on the interaction data received from the user device. At block 318, the method 300 ends.

FIG. 4 depicts a flow diagram illustrating a method 400 of generating shared parameters for a cluster, in accordance with some embodiments. Method 400 starts at block 402 and continues to block 404, where a set of structured features related to a set of candidate items is received. The structured features may include, but are not limited to, numerical attributes associated with each item such as item revenue, item price, average rating, etc. and/or categorical attributes such as brand, product category, product type, etc. At block 406, a set of clusters is generated based on the structured features. The clusters may be generated using any suitable clustering process, such as a DBSCAN process. Each cluster may each include a predetermined minimum number of hot items.

At block 408, which may be executed simultaneously and/or sequentially with blocks 404 and 406, a set of unstructured features is received. Unstructured features may include, but are not limited to, item descriptions, item titles, and item images. At block 410, semantic embeddings may be generated for each item in the set of candidate items based on the unstructured features. The semantic embeddings may be generated by an embedding model, such as a BERT model.

At block 412, a similarity matrix is generated. The similarity matrix may be generated based on the semantic embeddings generated at block 410 and/or the cluster identifiers generated at block 406. The similarity matrix may include a matrix indicating each element pair and the corresponding similarity measure. In some embodiments, the similarity matrix may be limited to similarity values for items in the same cluster to eliminate unwanted parameter sharing between clusters.

At block 414, which may be executed simultaneously and/or sequentially with blocks 404 and 406 and/or blocks 408-412, a mean or variance of an initial distribution of the set of candidate items is generated.

At block 416, distribution parameters for at least one item in a cluster is updated based on distribution parameters of one or more additional items in the corresponding cluster. Candidate items may be identified for receiving updated parameters based on one or more selection criteria. Candidate items selected for parameter updates may include “cold” items, e.g., items having an engagement value below a threshold value over a predetermined time period. Cold items may include, for example, new items added to the item catalog and/or existing items with low interaction values. In some embodiments, the candidate items selected for parameter updating may be updated based on parameters of one or more additional items in a corresponding cluster, such as, for example, a weighted average across the mean (μ^{t}) for a subset of items in the same cluster.

At block 418, an explore-exploit mechanism is applied using the updated parameters to generate a set of ranked candidate items. The explore-exploit ranker may include an exploitation mechanism, such as a Thompson sampling process, that utilizes the updated distribution parameters to select one or more candidate items for inclusion in the set of ranked candidate items. The explore-exploit ranker may additionally include an exploration mechanism, such as a multi-arm bandit process, for selecting one or more items for inclusion in the set of ranked candidate items. The updated distribution parameters provide increased exploration of updated candidate items without impacting either the exploitation of non-updated candidate items or exploration of the candidate items (e.g., only a point estimate is updated). At block 420, the method 400 ends.

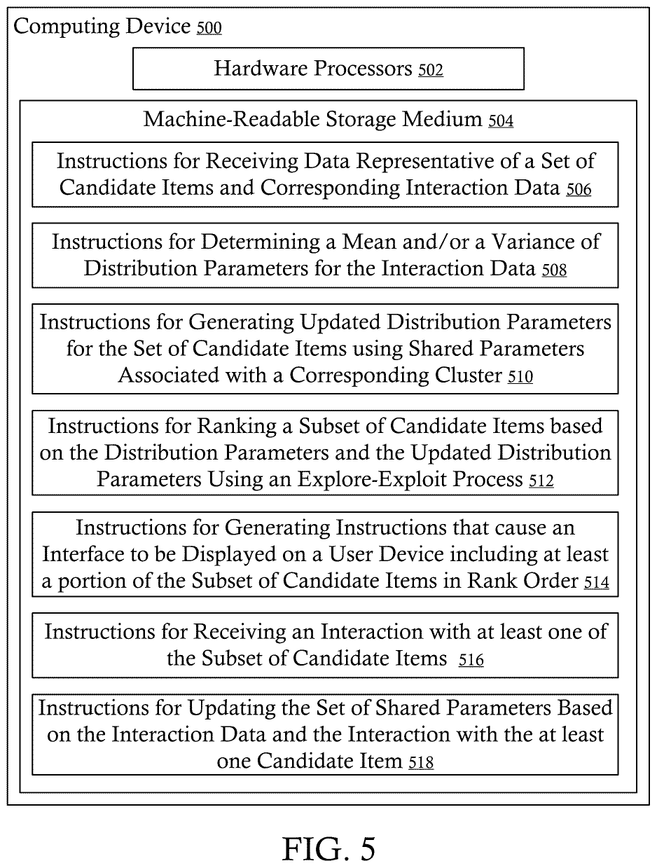

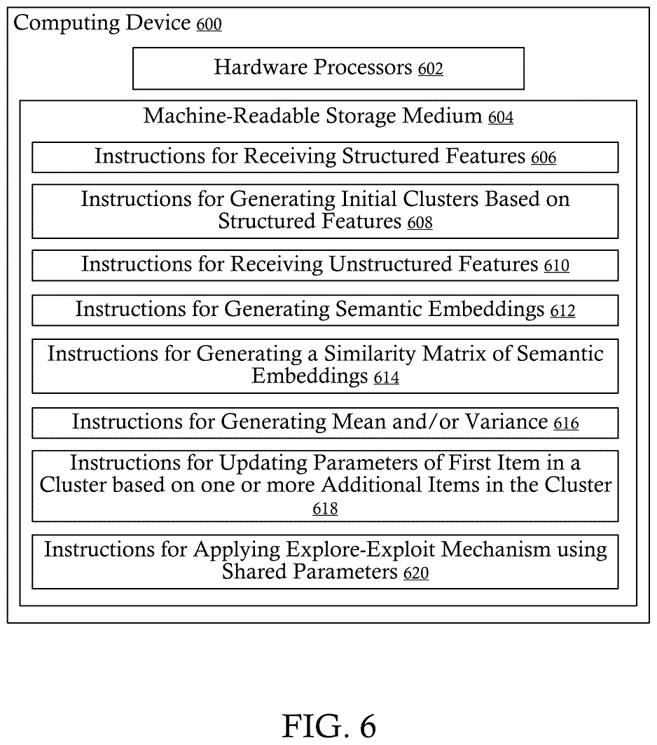

FIGS. 5 and 6 depict example systems 500, 600, respectively, that include non-transitory, machine-readable medium 504, 604, respectively, encoded with example instructions executable by processing resources 502, 602, respectively. In some implementations, the systems 500, 600 may be useful for implementing aspects of the shared parameter recommender 120 of FIG. 1, or for performing aspects of methods 300 400 of FIGS. 3 and 4, respectively. For example, the instructions encoded on machine-readable medium 504, 604 may be included in instructions 108 of FIG. 1. In some implementations, functionality described with respect to FIG. 1 may be included in the instructions encoded on machine-readable medium 504, 604.

The processing resources 502, 602 may include a microcontroller, a microprocessor, central processing unit core(s), an ASIC, an FPGA, and/or other hardware devices suitable for retrieval and/or execution of instructions from the machine-readable medium 504, 604 to perform functions related to various examples. Additionally, or alternatively, the processing resources 502, 602 may include or be coupled to electronic circuitry or dedicated logic for performing some or all of the functionality of the instructions described herein.

The machine-readable medium 504, 604 may be any medium suitable for storing executable instructions, such as RAM, ROM, EEPROM, flash memory, a hard disk drive, an optical disc, or the like. In some example implementations, the machine-readable medium 504, 604 may be a tangible, non-transitory medium. The machine-readable medium 504, 604 may be disposed within the systems 500, 600, respectively, in which case the executable instructions may be deemed installed or embedded on the system. Alternatively, the machine-readable medium 504, 604 may be a portable (e.g., external) storage medium and may be part of an installation package.

As described further herein, the machine-readable medium 504, 604 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIGS. 5 and 6.

With reference to FIG. 5, the machine-readable medium 504 includes instructions 506 to 518. Instructions 506, when executed, cause the processing resource 502 to receive data representative of a set of candidate items and corresponding interaction data. The set of candidate items may include elements representative of one or more elements associated with a network environment, such as one or more candidate items obtained from an item catalog associated with the network environment, and corresponding interaction data for each of the one or more elements.

Instructions 508, when executed, cause the processing resource 502 to determine a mean and a variance of a set of initial distribution parameters for the set of candidate items using the interaction data. The initial distribution may include a posterior distribution generated for the set of candidate items.

Instructions 510, when executed, cause the processing resource 502 to generate updated distribution parameters for the set of candidate items using shared parameters associated with a corresponding cluster. The shared parameters may be generated by clustering the set of candidate items into one or more clusters and modifying one or more parameters (e.g., a, B) of at least one candidate item in a cluster based on a weighted mean of one or more additional items in the corresponding cluster. For example, in some embodiments, parameters for one or more cold items may be updated based on a mean or variance of one or more hot items in the same cluster.

Instructions 512, when executed, cause the processing resource 502 to rank a subset of the candidate items based on the updated distribution parameters using an explore-exploit mechanism. The explore-exploit mechanism generates the subset of ranked candidate items from the set of candidate items based, at least in part, on the updated distribution parameters. The explore-exploit mechanism may include an exploitation mechanism, such as a Thompson sampling process, that utilizes the updated distribution parameters to select one or more candidate items for inclusion in the set of ranked candidate items. The explore-exploit mechanism may additionally include an exploration mechanism, such as a multi-arm bandit process, for selecting one or more items for inclusion in the set of ranked candidate items.

Instructions 514, when executed, cause the processing resource 502 to generate instructions that cause an interface to be displayed on a user device. The interface includes the ranked subset of candidate items in ranked order. The interface may be generated according to any suitable interface generation process, such as a template completion process.

Instructions 516, when executed, cause the processing resource 502 to receive interaction data for at least one candidate item in the ranked subset of candidate items from the user device. Instructions 518, when executed, cause the processing resource 502 to update the distribution parameters for the set of candidate items based, at least in part, on the interaction data received from the user device.

With reference to FIG. 6, the machine-readable medium 604 includes instructions 606 to 620. Instructions 606, when executed, cause the processing resource 602 to receive structured features. The structured features may include, but are not limited to, numerical attributes associated with each item such as item revenue, item price, average rating, etc. and/or categorical attributes such as brand, product category, product type, etc.

Instructions 608, when executed, cause the processing resource 602 to generate a set of clusters based on the structured features. The clusters may be generated using any suitable clustering process, such as a DBSCAN process. The clusters may each include a predetermined minimum number of hot items.

Instructions 610, when executed, cause the processing resource 602 receive a set of unstructured features. Unstructured features may include, but are not limited to, item descriptions, item titles, and item images.

Instructions 612, when executed, cause the processing resource 602 to generate semantic embeddings for each item in the set of candidate items based on the unstructured features. The semantic embeddings may be generated by an embedding model, such as a BERT model.

Instructions 614, when executed, cause the processing resource 602 to generate a similarity matrix of the semantic embeddings. The similarity matrix may be generated based on the semantic embeddings and/or the cluster identifiers. The similarity matrix may include a matrix indicating each element pair and a corresponding similarity measure. In some embodiments, the similarity matrix may be limited to similarity values for items in the same cluster to eliminate unwanted parameter sharing between clusters.

Instructions 616, when executed, cause the processing resource 602 to generate a mean or variance of an initial distribution of the set of candidate items.

Instructions 618, when executed, cause the processing resource 602 to update distribution parameters for at least one item in a cluster based on distribution parameters of one or more additional items in the corresponding cluster. Candidate items may be identified for receiving updated parameters based on one or more selection criteria. Candidate items selected for parameter updates may include “cold” items, e.g., items having an engagement value below a threshold value over a predetermined time period. Cold items may include, for example, new items added to the item catalog and/or existing items with low interaction values. In some embodiments, the candidate items selected for parameter updating may be updated based on parameters of one or more additional items in a corresponding cluster, such as, for example, a weighted average across the mean (μ^{t}) for a subset of items in the same cluster.

Instructions 620, when executed, cause the processing resource 602 to apply an explore-exploit mechanism using the updated parameters to generate a set of ranked candidate items. The explore-exploit ranker may include an exploitation mechanism, such as a Thompson sampling process, that utilizes the updated distribution parameters to select one or more candidate items for inclusion in the set of ranked candidate items. The explore-exploit ranker may additionally include an exploration mechanism, such as a multi-arm bandit process, for selecting one or more items for inclusion in the set of ranked candidate items. The updated distribution parameters provide increased exploration of updated candidate items without impacting either the exploitation of non-updated candidate items or exploration of the candidate items (e.g., only a point estimate is updated).

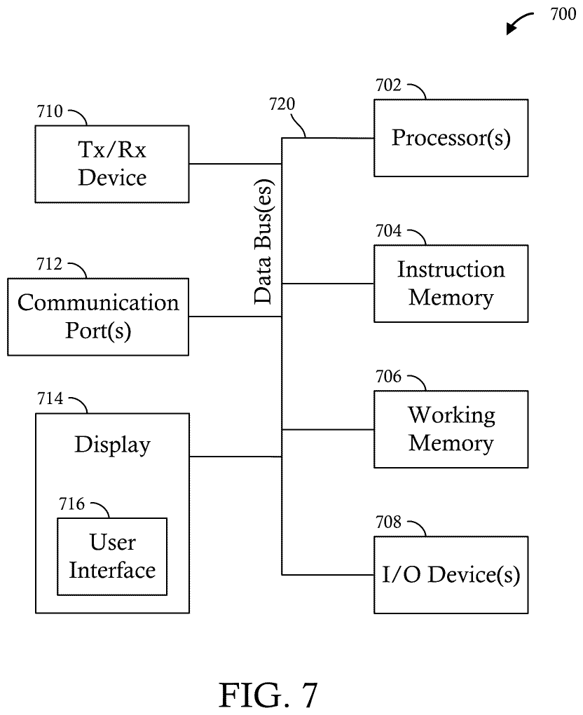

FIG. 7 illustrates a block diagram of a computing device 700, in accordance with some embodiments. Although FIG. 7 is described with respect to certain components shown therein, it will be appreciated that the elements of the computing device 700 may be combined, omitted, and/or replicated. In addition, it will be appreciated that additional elements other than those illustrated in FIG. 7 may be added to the computing device.

As shown in FIG. 7, the computing device 700 may include one or more processing resources 702, instruction memory 704, working memory 706, input/output devices 708, transceiver 710, communication ports 712, display 714, and/or any other suitable elements each operatively coupled to one or more data buses 720. The data buses 720 allow for communication among the various components. The data buses 720 may include wired, or wireless, communication channels.

The one or more processing resources 702 may include any processing circuitry operable to control operations of the computing device 700. In some embodiments, the one or more processing resources 702 include one or more distinct processors, each having one or more cores (e.g., processing circuits). Each of the distinct processors may have the same or different structure. The one or more processing resources 702 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 702 may also be implemented by a controller, a microcontroller, an application specific integrated circuit (ASIC), a field programmable gate array (FPGA), a programmable logic device (PLD), etc.

In some embodiments, the one or more processing resources 702 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 704 may store instructions that are accessed (e.g., read) and executed by at least one of the one or more processing resources 702. For example, the instruction memory 704 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 702 may perform a certain function or operation by executing code, stored on the instruction memory 704, embodying the function or operation. For example, the one or more processing resources 702 may execute code stored in the instruction memory 704 to perform one or more of any function, method, or operation disclosed herein.

Additionally, the one or more processing resources 702 may store data to, and read data from, the working memory 706. For example, the one or more processing resources 702 may store a working set of instructions to the working memory 706, such as instructions loaded from the instruction memory 704. The one or more processing resources 702 may also use the working memory 706 to store dynamic data created during one or more operations. The working memory 706 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 704 and working memory 706, it will be appreciated that the computing device 700 may include a single memory unit that operates as both instruction memory and working memory. Further, although embodiments are discussed herein including non-volatile memory, it will be appreciated that computing device 700 may include volatile memory components in addition to at least one non-volatile memory component.

In some embodiments, the instruction memory 704 and/or the working memory 706 includes an instruction set, in the form of a file for executing various methods, such as methods for parameter sharing and explore-exploit item selection, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 702.

The input/output devices 708 may include any suitable device that allows for data input or output. For example, the input/output devices 708 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 710 and/or the communication port(s) 712 allow for communication with a network. For example, if a communication network is a cellular network, the transceiver 710 allows communications with the cellular network. In some embodiments, the transceiver 710 is selected based on the type of the communication network the computing device 700 will be operating in. The one or more processing resources 702 are operable to receive data from, or send data to, a network, via the transceiver 710.

The communication port(s) 712 may include any suitable hardware, software, and/or combination of hardware and software that is capable of coupling the computing device 700 to one or more networks and/or additional devices. The communication port(s) 712 may be arranged to operate with any suitable technique for controlling information signals using a desired set of communications protocols, services, or operating procedures. The communication port(s) 712 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 712 allows for the programming of executable instructions in the instruction memory 704. In some embodiments, the communication port(s) 712 allow for the transfer (e.g., uploading or downloading) of data, such as machine learning model training data.

In some embodiments, the communication port(s) 712 couples the computing device 700 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 710 and/or the communication port(s) 712 utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 714 may be any suitable display, and may display the user interface 716. The user interfaces 716 may enable user interaction with sets of ranked candidate items presented via one or more interfaces. For example, the user interface 716 may be a user interface for an application of a network environment operator that allows a user to view and interact with the operator's website. In some embodiments, a user may interact with the user interface 716 by engaging the input/output devices 708. In some embodiments, the display 714 may be a touchscreen, where the user interface 716 is displayed on the touchscreen.

The display 714 may include a screen such as, for example, a Liquid Crystal Display (LCD) screen, a light-emitting diode (LED) screen, an organic LED (OLED) screen, a movable display, a projection, etc. In some embodiments, the display 714 may include a coder/decoder, also known as Codecs, to convert digital media data into analog signals. For example, the visual peripheral output device may include video Codecs, audio Codecs, or any other suitable type of Codec.

In some embodiments, the computing device 700 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 700 may be a computer, a workstation, a laptop, a server such as a cloud-based server, or any other suitable device. In some embodiments, the computing device 700 is a server that includes one or more processing units, such as one or more graphical processing units (GPUs), one or more central processing units (CPUs), and/or one or more processing cores. The computing device 700 may, in some embodiments, execute one or more virtual machines. In some embodiments, processing resources (e.g., capabilities) of the computing device 700 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

It will be appreciated that updating of parameters for use in explore-exploit mechanisms, as disclosed herein, particularly on large datasets intended to be used ecommerce network catalogs, is only possible with the aid of computer-assisted machine-learning algorithms and techniques, such as clustering models and/or semantic embedding generation models. In some embodiments, machine learning processes are used to perform operations that cannot practically be performed by a human, either mentally or with assistance, such as updating of distribution parameters on a cluster-by-cluster basis.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions that, when executed, cause the processor to:
receive interaction data for a set of candidate items;
determine a set of distribution parameters for the set of candidate items using the interaction data;
generate a set of updated distribution parameters based on a mean of the set of distribution parameters, wherein at least one updated parameter is associated with a first cluster of the set of candidate items;
rank a subset of candidate items based on the of updated distribution parameters using an explore-exploit process;
generate instructions that cause an interface to be displayed on a user device, wherein the interface includes at least a portion of the subset of candidate items in rank order;
receive an interaction with at least one candidate item of the subset of candidate items from the user device; and
update the set of distribution parameters based on the interaction with the at least one candidate item.

2. The system of claim 1, wherein a set of clusters including the first cluster is generated using at least one structured feature.

3. The system of claim 1, wherein the set of updated distribution parameters is generated, at least in part, based on a similarity matrix.

4. The system of claim 3, wherein the similarity matrix includes similarities for semantic embeddings of each candidate item in the set of candidate items.

5. The system of claim 4, wherein each semantic embedding comprises a Bidirectional encoder representations from transformers (BERT) embedding.

6. The system of claim 1, wherein the at least one shared parameter includes a parameter of a first item in the first cluster, and wherein the at least one shared parameter is provided for at least a second item in the first cluster.

7. The system of claim 6, wherein the first item is a hot item.

8. The system of claim 1, wherein the explore-exploit process comprises a Thompson Sampling process.

9. A computer-implemented method, comprising:
receiving interaction data for a set of candidate items;
determining distribution parameters for the set of candidate items using the interaction data;
generating updated distribution parameters for the set of candidate items, wherein the set of candidate items is clustered, and wherein the updated distribution parameters are generated based on at least one shared parameter of a first cluster and a mean of the distribution parameters;
ranking a subset of candidate items based on the updated distribution parameters using an explore-exploit process;
generating instructions that cause an interface to be displayed on a user device, wherein the interface includes at least a portion of the subset of candidate items in rank order;
receiving an interaction with at least one candidate item of the candidate items from the user device; and
updating the distribution parameters based on the interaction data and the interaction with the at least one candidate item.

10. The computer-implemented method of claim 9, wherein a set of clusters including the first cluster is generated using at least one structured feature.

11. The computer-implemented method of claim 9, wherein the set of updated distribution parameters is generated, at least in part, based on a similarity matrix.

12. The computer-implemented method of claim 11, wherein the similarity matrix includes similarities for semantic embeddings of each candidate item in the set of candidate items.

13. The computer-implemented method of claim 12, wherein each semantic embedding comprises a Bidirectional encoder representations from transformers (BERT) embedding.

14. The computer-implemented method of claim 9, wherein the at least one shared parameter includes a parameter of a first item in the first cluster, and wherein the at least one shared parameter is provided for at least a second item in the first cluster.

15. The computer-implemented method of claim 14, wherein the first item is a hot item.

16. The computer-implemented method of claim 9, wherein the explore-exploit process comprises a Thompson Sampling process.

17. A non-transitory computer-readable medium storing instructions that, when executed by at least one processor, cause a device to perform operations comprising:
receiving interaction data for a set of candidate items;
determining distribution parameters for the interaction data;
generating updated distribution parameters for the set of candidate items, wherein the set of candidate items is clustered, and wherein the updated distribution parameters are generated based on at least one shared parameter of a first cluster;
ranking a subset of candidate items based on the updated distribution parameters using an explore-exploit process;
generating instructions that cause an interface to be displayed on a user device, wherein the interface includes at least a portion of the subset of candidate items in rank order;
receiving an interaction with at least one candidate item of the subset of candidate items from the user device; and
updating the distribution parameters based on the interaction data and the interaction with the at least one candidate item.

18. The non-transitory computer-readable medium of claim 17, wherein a set of clusters including the first cluster is generated using at least one structured feature.

19. The non-transitory computer-readable medium of claim 17, wherein the set of updated distribution parameters is generated, at least in part, based on a similarity matrix including similarities for semantic embeddings of each candidate item in the set of candidate items.

20. The non-transitory computer-readable medium of claim 19, wherein each semantic embedding comprises a Bidirectional encoder representations from transformers (BERT) embedding.
